(19) United States
(12) Patent Application Publication
(10) Pub. No.: US 2021/0003881 A1
(43) Pub. Date: Jan. 7, 2021

(54) LIQUID CRYSTAL DISPLAY DEVICE

(71) Applicant: NIPPON SEIKI CO., LTD., Niigata (JP)

(72) Inventors: Yoshiyuki IIDA, Niigata (JP); Bunkichi KANEKO, Niigata (JP); Masao SATOH, Niigata (JP); Hiroyuki FURUSAWA, Niigata (JP); Tatsuya HASEGAWA, Niigata (JP); Toshiro TSURUMARU, Niigata (JP); Wataru SAITO, Niigata (JP)

(21) Appl. No.: 17/040,857

(22) PCT Filed: Apr. 19, 2019
(86) PCT No.: PCT/JP2019/016782

§ 371 Date: Sep. 23, 2020

(30) Foreign Application Priority Data
Apr. 26, 2018 (JP) 2018-085141

(51) Int. Cl. G02F 1/1333

(52) U.S. Cl. CPC G02F 1/133308; G09G 3/36

(57) ABSTRACT

A liquid crystal display device is provided with: a liquid crystal display panel; a hot mirror (transmissive panel) that is located ahead of the liquid crystal display panel and transmits light; packing that supports the periphery of the hot mirror; and a frame body that holds and secures the liquid crystal display panel and the packing. The frame body comprises a holder (first frame body) and a cover (second frame body) that are engaged and connected, a support portion penetrating the packing and located ahead of the liquid crystal display panel is provided in the holder, an elastic support portion facing the support portion and located behind the liquid display panel is provided in the cover, and the liquid crystal display panel is held and secured without being in contact with the packing while being sandwiched between the support portion and the elastic support portion.

### TECHNICAL FIELD

The present invention relates to a liquid crystal display device.

### BACKGROUND ART

Liquid crystal display devices for displaying information as an image are widely used. Such a liquid crystal display device is also used, for example, in a vehicle-mounted head-up display that emits display light for displaying an image from the liquid crystal display device to display a virtual image in front of a viewer. For example, in the head-up display disclosed in Patent Document 1 below, a liquid crystal display panel formed of a thin film transistor (TFT) is held via a packing in a TFT holder together with a hot mirror that protects a front surface of the liquid crystal display panel.

### PRIOR ART DOCUMENT

### Patent Document

Patent Document 1: Japanese Unexamined Patent Application Publication No. 2008-185633

### SUMMARY OF THE INVENTION

### Problems to be Solved by the Invention

In the configuration of Patent Document 1 described above, the liquid crystal display panel is pressed and held by a rubber surface of the packing, and it is thus difficult to perform control so that a fixing stress applied to the liquid crystal display remains constant, and this results in a problem in that uneven brightness occurs in the liquid crystal display panel due to an influence of the fixing stress. Further, the liquid crystal display panel is held via the packing such as a rubber, and thus, if the positioning accuracy is poor, an image may be affected by the display light.

The present invention has been contrived in view of the above problems, and an object thereof is to provide a liquid crystal display device capable of suppressing uneven brightness.

### Solution to Problem

To achieve the above object, a liquid crystal display device according to the present invention includes

a liquid crystal display panel,

a transmissive panel provided in front of the liquid crystal display panel and configured to transmit light,

a packing configured to support a periphery of the transmissive panel, and

a frame body configured to hold and fix the liquid crystal display panel and the packing.

The frame body includes a first frame body and a second frame body to be coupled in engagement with each other,

the first frame body is provided with a support portion penetrating the packing and being provided in front of the liquid crystal display panel,

the second frame body is provided with an elastic support portion facing the support portion and being provided behind the liquid crystal display panel, and

the liquid crystal display panel is sandwiched between the support portion and the elastic support portion to be held and fixed without abutting against the packing.

### Effect of the Invention

According to the present invention, it is possible to suppress uneven brightness.

### BRIEF DESCRIPTION OF THE DRAWINGS

FIGS. 1(a) and 1(b) relate to an embodiment of a liquid crystal display device according to the present invention. FIG. 1(a) is an external perspective view in which a part of the liquid crystal display device is enlarged, and FIG. 1(b) is a central vertical cross-sectional view of the liquid crystal display device.

FIG. 2 is an exploded perspective view according to the embodiment of the present invention.

FIG. 3 is a partially enlarged perspective view for describing a relationship between a liquid crystal display panel and a cover according to the embodiment of the present invention.

FIG. 4 is a partially enlarged perspective view for describing a relationship between a holder and a packing according to the embodiment of the present invention.

FIG. 5 is a partially enlarged perspective view for describing a relationship between the holder and a hot mirror according to the embodiment of the present invention.

FIG. 6 is a front view for describing the relationship between the holder and the packing according to the embodiment of the present invention.

FIG. 7 is a partially enlarged perspective view for describing the relationship between the packing and the hot mirror according to the embodiment of the present invention.

### MODE FOR CARRYING OUT THE INVENTION

A liquid crystal display device according to an embodiment of the present invention will be described in detail with reference to the drawings.

A liquid crystal display device 10 according to the present embodiment is used, for example, as a display component of a vehicle-mounted head-up display that that emits display light for displaying an image such as vehicle information to display a virtual image in front of a viewer. The liquid crystal display device 10 emits display light representing an image from the liquid crystal display device 10 toward a windshield of the vehicle. A viewer (mainly a driver of the vehicle) receives the display light reflected by the windshield and visually recognizes a virtual image superimposed on a scenery that the viewer sees through the windshield. Usually, a mirror member such as a concave mirror is arranged in an optical path of the display light from the liquid crystal display device 10 to the windshield.

The liquid crystal display device 10 according to the present invention includes a liquid crystal display panel 11, a transmissive panel 12 provided in front of the liquid crystal display panel 11 and configured to transmit light, a packing 13 serving as a buffer member for supporting a periphery of the transmissive panel 12, and a frame body 20 configured to hold and fix the liquid crystal display panel 11 and the packing 13. The frame body 20 includes a first frame body 21 and a second frame body 31 to be coupled in engagement with each other. The first frame body 21 is provided with a support portion 22 penetrating the packing 13 and being provided in front of the liquid crystal display panel 11. The second frame body 31 is provided with an elastic support portion 32 facing the support portion 22 and being provided behind the liquid crystal display panel 11. The liquid crystal display panel 11 is sandwiched between the support portion 22 and the elastic support portion 32 to be held and fixed without abutting against the packing 13.

Thus, it is possible to suppress uneven brightness due to a force applied to hold and fix the liquid crystal display device 10 and improve the positioning accuracy.

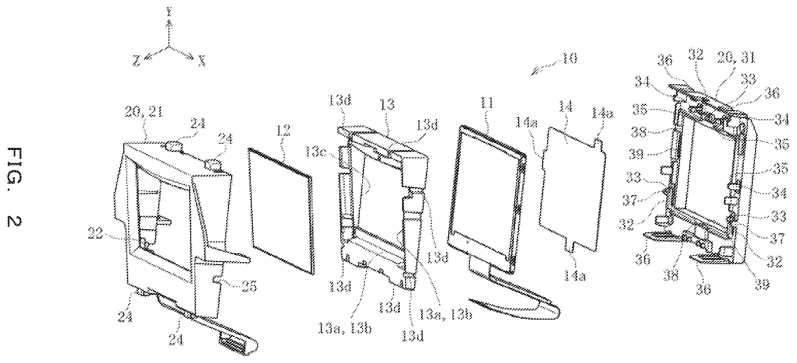

As illustrated in FIG. 2, the liquid crystal display device 10 according to the present embodiment includes the liquid crystal display panel 11, a hot mirror (transmissive panel) 12 in front of the liquid crystal display panel 11, the packing 13 configured to support the periphery of the hot mirror 12, a diffusion plate 14 behind the liquid crystal display panel 11, and the frame body 20. The liquid crystal display panel 11 is sandwiched between a holder (first frame body) 21 and a cover (second frame body) 31 which are included in the frame body 20, and is housed without abutting against the packing 13.

The liquid crystal display panel 11 is, for example, a color liquid crystal module, and is formed of a dot matrix type TFT module.

The liquid crystal display panel 11 receives light from a backlight unit (not illustrated), forms an image, and emits the image as display light. The liquid crystal display panel 11 includes a liquid crystal cell including a pair of transparent substrates and a liquid crystal layer enclosed between the pair of transparent substrates, and polarizing filters facing each other with the liquid crystal cell interposed therebetween. Transparent electrodes formed of indium tin oxide (ITO) or the like are formed on the transparent substrates. The liquid crystal display panel 11 is connected to a driver and a control unit (not illustrated) for the liquid crystal display panel 11 mounted on a circuit board. In the liquid crystal display panel 11, if a drive voltage is applied to the liquid crystal layer via the transparent electrodes under the control of the control unit, the orientation of the liquid crystal molecules in the liquid crystal layer is controlled, and each of a plurality of pixels included in the liquid crystal display panel 11 is switched to a transmissive/non-transmissive state. With such a combination of the pixels, the liquid crystal display panel 11 forms a predetermined image and emits the image as display light. The control unit acquires vehicle information such as a vehicle speed from an electronic control unit (ECU) of the vehicle, for example, and emits acquired image information as display light.

The hot mirror 12 is provided on a front side (in front) of the liquid crystal display panel 11. The hot mirror 12 includes a multilayer film on a transparent glass, and thus, the hot mirror 12 transmits visible light and reflects infrared light, and therefore, provides protection from a temperature increase in the liquid crystal display panel 11 and the like.

The diffusion plate 14 is provided on a rear side of (behind) the liquid crystal display panel 11. The diffusion plate 14 uniformly diffuses light incident on the liquid crystal display panel 11 from the backlight unit (not illustrated). As illustrated in FIG. 2, the diffusion plate 14 is formed in a rectangular shape larger than an opening portion of the frame-shaped cover 31, and positioning pieces 14a protruding from an upper, lower, and one lateral sides of the diffusion plate 14 are integrally formed with the diffusion plate 14 at the three locations.

The frame body 20 is formed in a rectangular frame shape corresponding to an outer shape of the liquid crystal display panel 11, and the liquid crystal display panel 11 is housed in the frame body 20 to be held and fixed by the frame body 20. The frame body 20 is formed of a resin (for example, polypropylene). The frame body 20 includes the holder 21 having a substantially L-shaped cross-section and the cover 31 having a substantially L-shaped cross section, which are engaged and coupled. The holder 21 and the cover 31 are coupled in engagement with each other to form the frame body 20 having a substantially U-shaped cross section and an opening inside.

The holder 21 is arranged in front of the liquid crystal display panel 11. The holder 21 has a wide upper side and a narrow lower side, and a side surface shape of the holder 21 is formed in a substantially trapezoidal shape.

The cover 31 is arranged behind the liquid crystal display panel 11 and is coupled in engagement with the holder 21.

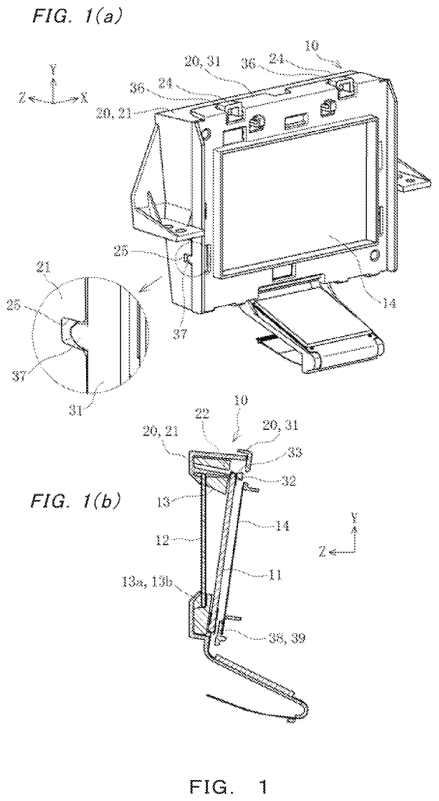

The cover 31 is formed so that the widths of an upper side, a lower side, and both lateral sides of the cover 31 are constant, and if the cover 31 is vertical in a state where the holder 21 is coupled in engagement with the cover 31, an upper part of the holder 21 protrudes forward and a lower part of the holder 21 is closer to the rear side (see FIGS. 1(a), 1(b), and 2).

The liquid crystal display panel 11, the hot mirror 12, the packing 13, and the diffusion plate 14 are housed between the holder 21 and the cover 31.

In the liquid crystal display device 10, the liquid crystal display panel 11 is directly sandwiched between the holder 21 and the cover 31 to be held and fixed without contacting (abutting against) the packing 13.

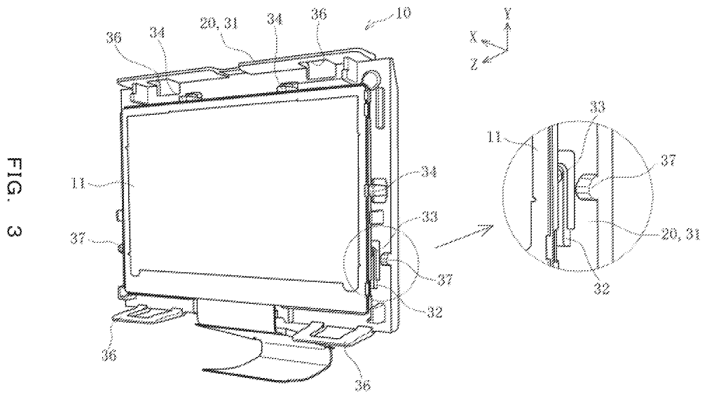

That is, as illustrated in FIGS. 2 and 3, the elastic support portion 32 is integrally formed with the cover 31 made of resin, a base end of the elastic support portion 32 is coupled to the cover 31, and a tip end of the elastic support portion 32 is formed into a free arm shape. As a result, the elastic support portion 32 is in an arm shape having elasticity resulting from the resin. A pressing portion 33 to be placed against the liquid crystal display panel 11 is provided at a tip end portion of the elastic support portion 32. The elastic support portion 32 is provided at three locations, that is, at a central portion of an upper side portion and at a lower portion of left and right lateral side portions of the rectangular frame-shaped body of the cover 31, and restricts and retains a position of a flat surface (rear surface) of the liquid crystal display panel 11.

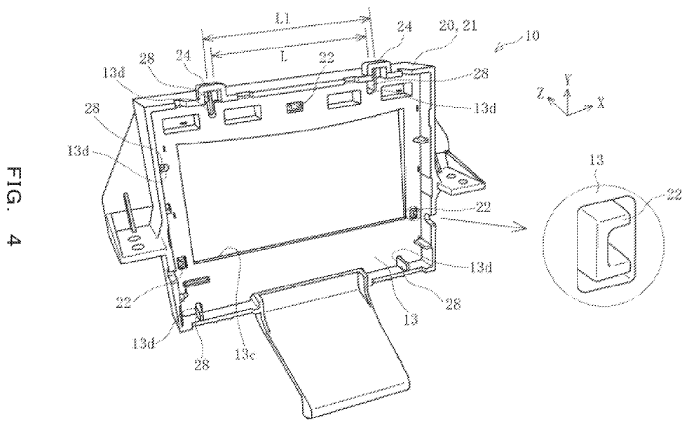

As illustrated in FIGS. 4 to 6, in the holder 21 made of resin, the support portion 22 having a U-shaped cross section and opening toward the outside of the holder 21 is formed at a position facing the pressing portion 33 at the tip end of the elastic support portion 32 of the cover 31. The support portion 22 is provided to penetrate the packing 13, a tip end portion of the support portion 22 is provided to protrude from the packing 13, and the support portion 22 is provided at three locations, that is, at an upper side portion and left and right lateral side portions of the holder 21.

Thus, front and back surfaces of the liquid crystal display panel 11 can be sandwiched from both sides to be held between the elastic support portion 32 of the cover 31 and the support portion 22 of the holder 21 without contacting (abutting against) the packing 13, and thus, a position of a panel surface of the liquid crystal display panel 11 on an X-Y plane is restricted in a Z direction.

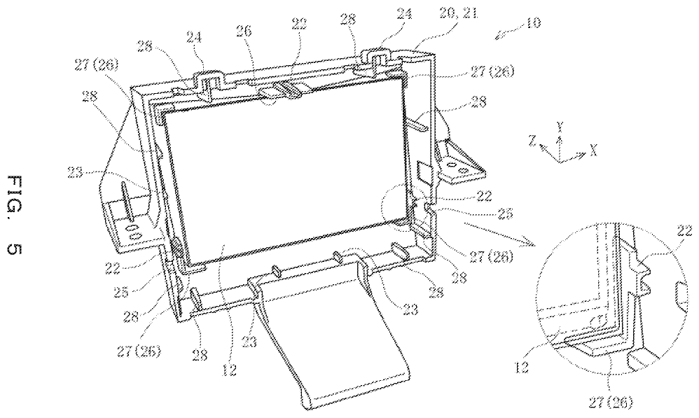

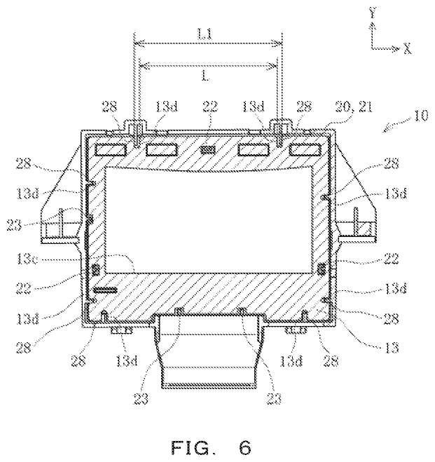

Further, as illustrated in FIG. 5, to restrict the positions of the liquid crystal display panel 11 in an X direction and in a Y direction, two rib-shaped positioning portions 28 against which a lower side portion of the liquid crystal display panel 11 is placed are formed in a lower side portion of the holder 21, and two rib-shaped positioning portions 28 against which one lateral side portion of the liquid crystal display panel 11 is placed are formed in one lateral side portion (the right side portion in FIGS. 5 and 6) of the holder 21.

As illustrated in FIGS. 2 and 3, two positioning guide portions 34 are formed in the upper side portion of the cover 31, and the liquid crystal display panel 11 can be moved downward by pushing an inclined portion 35 against the liquid crystal display panel 11.

Therefore, the liquid crystal display panel 11 is guided to be placed against the positioning portions 28 of the holder 21 and is positioned in an up-down direction (Y direction).

The two positioning guide portions 34 are formed on a lateral side portion (left side portion in FIGS. 5 and 6) of the cover 31 on an opposite side of the positioning portions 28 of the holder 21, and the inclined portion 35 is pushed against the liquid crystal display panel 11 to guide the liquid crystal display panel 11, the liquid crystal display panel 11 can be moved laterally. As a result, the liquid crystal display panel 11 is guided to be placed against the lateral positioning portions 28 of the holder 21 and is positioned in a left-right direction (X direction).

Therefore, the position of the liquid crystal display panel 11 is restricted and the liquid crystal display panel 11 is positioned in the X direction, the Y direction, and the Z direction by the support portion 22 and the elastic support portion 32, and by the positioning portions 28 and the positioning guide portions 34 at the upper and lower side portions and the lateral side portions, and thus, the liquid crystal display panel 11 is held and fixed between the holder 21 and the cover 31 without (abutting against) the packing 13.

It is noted that a structure in which the packing 13 does not contact the liquid crystal display panel 11 will be described later.

Further, the holder 21 and the cover 31 are engaged and coupled to be fitted with each other.

That is, two coupling protrusion portions 24 protruding upward are formed on each of an upper side portion and a lower side portion of an outer surface of the holder 21, and the cover 31 is formed with coupling frame portions 36 to engage with the coupling protrusion portions 24 to surround the outside of the coupling protrusion portions 24.

Therefore, the coupling frame portions 36 of the cover 31 are pushed to place over the coupling protrusion portions 24 of the holder 21, and the coupling frame portions 36 are positioned in a state where the coupling frame portions 36 place over the coupling protrusion portions 24, and thus, the holder 21 and the cover 31 can be held in a coupled state.

As illustrated in FIGS. 1(a) and 1(b), to position the holder 21 and the cover 31, engaging concave portions 25 are formed along the Z direction at both side surfaces of the holder 21 and engaging protrusion portions 37 to fit into the engaging concave portions 25 are formed at both side surfaces of the cover 31 to protrude in the Z direction. The positions of the holder 21 and the cover 31 in the Y direction are restricted by the engaging concave portions 25 and upper and lower surfaces of the engaging protrusion portions 37, and the positions of the holder 21 and the cover 31 in the X direction are restricted by the engaging concave portions 25 at both sides and inner surfaces of the engaging protrusion portions 37.

Further, a tip end portion of the engaging protrusion portion 37 is formed into a slanted surface having a thin shape so that the insertability into the engaging concave portion 25 can be improved.

It is noted that the position of the holder 21 and the cover 31 being coupled in engagement with each other is restricted in the Z direction by a reaction force acting between the support portion 22 of the holder 21 and the elastic support portion 32 of the cover 31 via the liquid crystal display panel 11.

The hot mirror 12 is held and fixed in the frame body 20 via the packing 13.

As illustrated in FIG. 5, four hot mirror receiving portions 27 for the hot mirror 12 are provided inside the holder 21. The hot mirror receiving portions 27 form corner support portions against which the four corners of the hot mirror 12 are placed and which restrict the position of the hot mirror 12 at the four corners. The four hot mirror receiving portions 27 are formed and arranged to provide gaps in the up-down direction (Y direction) and the left-right direction (X direction) with respect to the size of the hot mirror 12.

The packing 13 attached to the holder 21 is placed against a rear surface of the hot mirror 12 and pushes the hot mirror 12.

As illustrated in FIG. 2, the packing 13 is formed so that an upper side of the packing 13 is wide, and a lower side of the packing 13 is narrow in accordance with an outer shape of the holder 21 and a side surface shape of the packing 13 is formed in a substantially trapezoidal shape. Thus, in a state where the hot mirror 12 is mounted in the holder 21 with the packing 13 placed against the rear surface of the hot mirror 12 and the cover 31 is coupled in engagement with the holder 21, and in a state where the hot mirror 12 is vertical, the liquid crystal display panel 11 is in an inclined state where an upper side portion of the liquid crystal display panel 11 is separated from a vertical plane and a lower side portion of the liquid crystal display panel 11 is close to the vertical plane. That is, the liquid crystal display panel 11 and the hot mirror 12 are not parallel to each other, but are housed in the holder 21 and the cover 31 in an inclined state in which upper edge portions of the liquid crystal display panel 11 and the hot mirror 12 are separated from each other.

As illustrated in FIGS. 3 and 5, a plurality of packing receiving portions 26 configured to support a periphery of a front surface of the packing 13 are formed in the holder 21 to protrude to the rear side, and the packing receiving portions 26 support an outer peripheral side of the front surface of the packing 13 placed against the rear surface of the hot mirror 12. End faces of the hot mirror receiving portions 27 also serve for the packing receiving portions 26.

The support portion 22 configured to support the front surface of the liquid crystal display panel 11 is defined as a length by which the support portion 22 protrudes from a through hole of the packing 13 to the rear in a state where the packing 13 is supported by the holder 21. Thus, the packing 13 is mounted in the holder 21 without contacting (abutting against) the liquid crystal display panel 11, and the packing 13 contacts the hot mirror 12 to support the hot mirror 12.

The packing 13 is integrally formed with an inclined pressing portion 13a that positions the hot mirror 12.

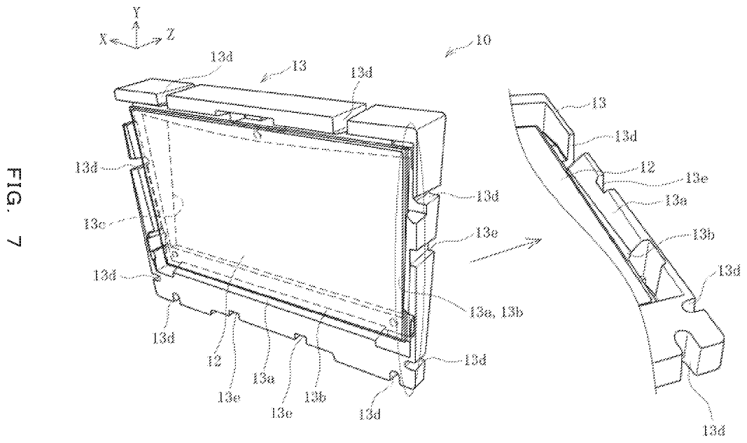

As illustrated in FIGS. 1(b) and 7, the inclined pressing portion 13a is arranged in a middle portion between two of the hot mirror receiving portions 27, and an inclined surface 13b is pushed against an end surface of the hot mirror 12 to eliminate the gap and position the hot mirror 12. Therefore, the inclined pressing portions 13a are provided correspondingly to two orthogonal sides where the two hot mirror receiving portions 27 are located, for example, the inclined pressing portions 13a are provided on one of the lateral side portions and the lower side portion. Thus, the hot mirror 12 is positioned in a state where there is no gap between the two hot mirror receiving portions 27 and the inclined pressing portion 13a on the upper side portion and the two hot mirror receiving portions 27 on opposing lateral side portions.

The packing 13 is formed of an elastic material such as a rubber or elastomer, or a porous material such as polyurethane foam, and includes a rectangular opening portion 13c corresponding to a display surface of the liquid crystal display panel 11. It is necessary to mount the packing 13 in the holder 21 in a state where the rectangular opening portion 13c is secured even if distortion or the like occurs.

As illustrated in FIGS. 4 and 6, notch portions (locked portions) 13d opening outward and penetrating in a front-back direction are formed as pairs with an interval L on each of the fours side portions in the packing 13.

On the other hand, the pair of positioning portions (locking portions) 28 to be locked to the pair of notch portions 13d are provided in the holder 21 at positions corresponding to the notch portions 13d, and an interval L1 between the pair of positioning portions 28 is set larger than the interval L between the pair of notch portions 13d. It is noted that the positioning portions 28 also serve as the above-described positioning portions 28 configured to position the liquid crystal display panel 11 in the X direction and the Y direction.

Therefore, outer surfaces of the pair of positioning portions 28 are placed against outer surfaces of the pair of notch portions 13d, and thus, each side of the packing 13 can be expanded to both sides, and the opening portion 13c can be secured.

Further, as illustrated in FIG. 7, notches 13e are formed in an outer shape portion of the packing 13 where the inclined pressing portions 13a are formed. If the notches 13e are inserted into the holder 21, the notches 13e are pressed against ribs 23 of the holder 21 illustrated in FIG. 6 in the X and Y directions. Therefore, the inclined pressing portions 13a of the packing 13 press against the hot mirror 12, and thus, it is possible to suppress an excessive widening of the opening portion 13c of the packing 13 to prevent unnecessary transmission light outside a display area of the liquid crystal display panel 11, reflection due to external light, and the like.

As illustrated in FIGS. 1(b) and 2, a rectangular mounting groove 38 is formed inside the cover 31, a positioning insertion hole 39 is formed to communicate with the mounting groove 38, and the front and back surfaces of the positioning insertion hole 39 are covered, in the cover 31, to mount the diffusion plate 14.

Therefore, the four sides of the periphery of the diffusion plate 14 are positioned in the mounting groove 38, and the positioning piece 14a is inserted into the insertion hole 39, and thus, the diffusion plate 14 is positioned and attached in a state where the diffusion plate 14 is embedded in the cover 31. Therefore, the diffusion plate 14 is mounted in the cover 31 in a state where the diffusion plate 14 does not contact the liquid crystal display panel 11 arranged on the front side.

With such a liquid crystal display device 10, the liquid crystal display panel 11, the hot mirror 12, the packing 13, and the diffusion plate 14 are attached and housed in a state where the liquid crystal display panel 11, the hot mirror 12, the packing 13, and the diffusion plate 14 are positioned between the holder 21 and the cover 31. Thus, the liquid crystal display panel 11 is held and fixed by the support portion 22 and the elastic support portion 32 without abutting against the packing 13.

As specifically described above in detail together with the embodiment, the liquid crystal display device 10 according to the present invention includes the liquid crystal display panel 11, the hot mirror (transmissive panel) 12 provided in front of the liquid crystal display panel 11 and configured to transmit light, the packing 13 configured to support the periphery of the hot mirror 12, and the frame body 20 configured to hold and fix the liquid crystal display panel 11 and the packing 13. The frame body 20 includes the holder (first frame body) 21 and the cover (second frame body) 31 to be coupled in engagement with each other. The holder 21 is provided with the support portion 22 penetrating the packing 13 and being provided in front of the liquid crystal display panel 11. The cover 31 is provided with the elastic support portion 32 facing the support portion 22 and being provided behind the liquid crystal display panel 11. The liquid crystal display panel 11 is sandwiched between the support portion 22 and the elastic support portion 32 to be held and fixed without abutting against the packing 13.

With such a configuration, the liquid crystal display panel 11 held by the holder 21 and the cover 31 is supported by the support portion 22 and the elastic support portion 32 without the packing 13 formed of an elastic body such as rubber being interposed, and thus, the liquid crystal display panel 11 can be held uniformly with a constant fixing force, and no biased force is applied to the liquid crystal display panel 11, so that it is possible to suppress occurrence of uneven brightness. Further, the liquid crystal display panel 11 is held and fixed without the packing 13 being interposed, and thus, it is possible to improve positioning accuracy, and emit display light for displaying an image of excellent quality. Further, the liquid crystal display panel 11 is pressed by the support portion 22 and the elastic support portion 32, and thus, a pressing force can be adjusted and controlled to press the liquid crystal display panel 11. Further, a necessary function such as a rigidity of the packing 13 can be freely set independently from the holding of the liquid crystal display panel 11.

According to the liquid crystal display device 10 of the present invention, the positioning portion 28 against which the liquid crystal display panel 11 is placed is provided in any one of the holder 21 and the cover 31, and the positioning guide portion 34 against which the liquid crystal display panel 11 is placed and which guides the liquid crystal display panel 11 toward the positioning portion 28 is provided in the other one of the holder 21 and the cover 31.

With such a configuration, the liquid crystal display panel 11 is guided and pushed toward the positioning portion 28 by the positioning guide portion 34, and thus, it is possible to position the liquid crystal display panel 11 at a predetermined position.

Therefore, the positioning accuracy of the liquid crystal display panel 11 can be improved to improve the image quality.

According to the liquid crystal display device 10 of the present invention, the engaging concave portion 25 for engaging and positioning the holder 21 and the cover 31 is provided in any one of the holder 21 and the cover 31, and the engaging protrusion portion 37 that fits into the engaging concave portion 25 is provided in the other one of the holder 21 and the cover 31.

With such a configuration, the holder 21 and the cover 31 can be positioned at a predetermined position by the engaging concave portion 25 and the engaging protrusion portion 37, and thus, the liquid crystal display panel 11 and the like housed in the holder 21 and the cover 31 can be positioned with high accuracy.

According to the liquid crystal display device 10 of the present invention, the pair of notch portions (locked portions) 13d are formed in the packing 13 with an interval L on each side of the opening portion 13c, and the pair of positioning portions (locking portions) 28 locked to the pair of notch portions 13d are formed in any one of the holder 21 and the cover 31. The interval L1 between the positioning portions 28 is larger than the interval L between the notch portions 13d, and thus, the positioning portions 28 are placed against both outer sides of the notch portions 13d and are locked with the notch portions 13d.

Thus, in the packing 13, the opening portion 13c is pushed and expanded outward by the positioning portions 28 inserted into the notch portions 13d, and thus, it is possible to prevent the opening portion 13c from narrowing due to distortion and the like so that a display range of the liquid crystal display panel 11 is not covered by the packing 13.

According to the liquid crystal display device 10 of the present invention, the hot mirror 12 is positioned by the hot mirror receiving portions (corner support portions) 27 that are provided in the holder 21 of the frame body 20 and restrict the position of the hot mirror 12 at the four corners, and the inclined pressing portion 13a provided in the packing 13 between two of the hot mirror receiving portions 27 and pushes the hot mirror 12 toward the other two hot mirror receiving portions 27.

Therefore, by pressing the hot mirror 12 with the packing 13, one side of the hot mirror 12 is pressed by the inclined surface 13b of the inclined pressing portion 13a of the packing 13 against the hot mirror receiving portions 27 on the other side, and thus, the hot mirror 12 can be positioned.

It is noted that an example where a TFT module is applied for the liquid crystal display panel 11 is described in the embodiment above, however, another liquid crystal display panel may be employed.

Further, in the above-described embodiment, a case where the liquid crystal display device is applied to an on-vehicle head-up display is described for an example. However, the liquid crystal display device is not limited to an on-vehicle application, and the liquid crystal display device may be mounted in a transportation such as an airplane, and a ship.

Further, the present invention is not limited to the above-described embodiment, and can be implemented in various aspects.

For example, the support portion and the elastic support portion configured to support the liquid crystal display panel 11 may be switched with each other for installation in the holder and the cover. Similarly, the positioning portion and the positioning guide portion, and the engaging concave portion and the engaging protrusion portion may also be switched with each other for installation in the holder and the cover, and needless to say, various improvements and design changes can be made without departing from the gist of the present invention.

### DESCRIPTION OF REFERENCE NUMERALS

10 Liquid crystal display device
11 Liquid crystal display panel
12 Hot mirror (transmissive panel)
13 Packing
13a Inclined pressing portion
13b Inclined surface
13c Opening portion
13d Notch portion
13e Notch
14 Diffusion plate
14a Positioning piece
20 Frame body
21 Holder (first frame body)
22 Support portion
23 Rib
24 Coupling protrusion portion
25 Engaging concave portion
26 Packing receiving portion
27 Hot mirror receiving portion (corner support portion)
28 Positioning portion
31 Cover (second frame body)
32 Elastic support portion
33 Pressing portion
34 Positioning guide portion
35 Inclined portion
36 Coupling frame portion
37 Engaging protrusion portion
38 Mounting groove
39 Insertion hole
L Interval
L1 Interval

1. A liquid crystal display device comprising:
a liquid crystal display panel;
a transmissive panel provided in front of the liquid crystal display panel and configured to transmit light,
a packing configured to support a periphery of the transmissive panel; and
a frame body configured to hold and fix the liquid crystal display panel and the packing, wherein
the frame body includes a first frame body and a second frame body to be coupled in engagement with each other,
the first frame body is provided with a support portion penetrating the packing and being provided in front of the liquid crystal display panel,
the second frame body is provided with an elastic support portion facing the support portion and being provided behind the liquid crystal display panel, and
the liquid crystal display panel is sandwiched between the support portion and the elastic support portion to be held and fixed without abutting against the packing.

2. The liquid crystal display device according to claim 1, wherein any one of the first frame body and the second frame body is provided with a positioning portion against which the liquid crystal display panel is placed, and the other one of the first frame body and the second frame body is provided with a positioning guide portion against which the liquid crystal display panel is placed, the positioning guide portion configured to guide the liquid crystal display panel toward the positioning portion.

3. The liquid crystal display device according to claim 1, wherein any one of the first frame body and the second frame body is provided with an engaging concave portion configured to engage and position the first frame body and the second frame body, and the other one of the first frame body and the second frame body is provided with an engaging protrusion portion configured to fit into the engaging concave portion.

4. The liquid crystal display device according to claim 1, wherein a pair of locked portions are formed with an interval on each side of an opening portion in the packing,
a pair of locking portions locked to the pair of locked portions are formed in any one of the first frame body and the second frame body, and
an interval between the locking portions is larger than an interval between the locked portions so that the locking portions are placed against both outer sides of the locked portions to be locked.

5. The liquid crystal display device according to claim 1, wherein the transmissive panel is positioned by
corner support portions provided in the frame body and configured to restrict positions of four corners of the transmissive panel, and
an inclined pressing portion provided in the packing between two of the corner support portions and configured to push the transmissive panel toward the other two of the corner support portions.

6. The liquid crystal display device according to claim 2, wherein any one of the first frame body and the second frame body is provided with an engaging concave portion configured to engage and position the first frame body and the second frame body, and the other one of the first frame body and the second frame body is provided with an engaging protrusion portion configured to fit into the engaging concave portion.
